(19) United States
(12) Patent Application Publication
(10) Pub. No.: US 2017/0307564 A1
(43) Pub. Date: Oct. 26, 2017

(54) DETECTION OF PORPHYRINS IN SUBTERRANEAN FORMATIONS

(71) Applicant: Halliburton Energy Services, Inc., Houston, TX (US)

(72) Inventors: Jing Shen, Houston, TX (US); Cyrus Irani, Houston, TX (US)

(73) Assignee: Halliburton Energy Services, Inc., Houston, TX (US)

(21) Appl. No.: 15/516,830

(22) PCT Filed: Nov. 12, 2015
(86) PCT No.: PCT/US2015/060411

§ 371 Date: Apr. 4, 2017

(51) Int. Cl. G01N 27/48; G01N 21/31; G01N 21/75; E21B 49/08

(52) U.S. Cl. CPC G01N 27/48; G01N 21/75; E21B 49/08; G01N 21/31; E21B 2049/085

(57) ABSTRACT

Methods and systems for the use of a thin-layer spectroelectrochemical cell to detect porphyrins in a wellbore environment are provided. In one embodiment, methods for the use of a thin-layer spectroelectrochemical cell to detect porphyrins in a wellbore environment comprises: positioning a spectroelectrochemical cell in a wellbore penetrating at least a portion of a subterranean formation comprising a downhole fluid; allowing at least a portion of the downhole fluid to flow into the spectroelectrochemical cell; and detecting at least one compound in at least a portion of the downhole fluid, wherein the at least one compound is selected from the group consisting of: a porphyrin, a metalloporphyrin, a porphyrin derivative, a porphyrin-like macrocycle, and any combination thereof.

### BACKGROUND

The present disclosure relates generally to methods and systems for detecting porphyrins in a wellbore environment. Hydrocarbons, such as oil and gas, are commonly obtained from subterranean formations that may be located onshore or offshore. The development of subterranean operations and the processes involved in removing hydrocarbons from a subterranean formation typically involve a number of different steps such as, for example, drilling a wellbore at a desired well site, treating the wellbore to optimize production of hydrocarbons, and performing the necessary steps to produce and process the hydrocarbons from the subterranean formation.

Porphyrins in subterranean formations may indicate petroleum maturity, help establish the biological origins of petroleum, provide paleoenvironmental information, and offer insight into potential problems that might arise during downstream processing of the fluid. Converting a complex crude oil into useful fractions requires a considerable amount of downstream refining, which is usually facilitated by reactions in the presence of catalysts. However, some catalysts are poisoned by the heavy metals (e.g., Ni and V) often present in porphyrins. In addition, porphyrin molecules may form rigid films at the oil-water interface, which is detrimental to the transportation and downstream handling of crude oils. These downstream complications may affect how crude oil is refined, which refinery refines it, how it is transported, and many other variables. Consequently, early detection and quantification of porphyrin-type molecules in a wellbore is a valuable aspect of any wellbore fluid analysis.

Typically, the presence and concentration of porphyrins is determined by an assay. However, assays cannot be performed in a wellbore and require more sample fluid than can usually be recovered during open hole operations. Accordingly, testing for porphyrins may be delayed.

### BRIEF DESCRIPTION OF THE DRAWINGS

These drawings illustrate certain aspects of some of the embodiments of the present disclosure and should not be used to limit or define the claims.

FIG. 1 is a diagram illustrating the chemical structure of porphyrins and metalloporphyrins in accordance with certain embodiments of the present disclosure.

FIG. 2 is a diagram of a thin-layer spectroelectrochemical cell in accordance with certain embodiments of the present disclosure.

FIG. 3 is a block diagram non-mechanistically illustrating how spectroelectrochemical evaluation of a sample is achieved using the thin-layer spectroelectrochemical cell in accordance with certain embodiments of the present disclosure.

FIG. 4 is a graph illustrating an ultraviolet-visible absorption spectrum of a porphyrin in accordance with certain embodiments of the present disclosure.

FIG. 5 is a graph illustrating ultraviolet-visible absorption spectra of a free-base porphyrin and metalloporphyrins in accordance with certain embodiments of the present disclosure.

FIG. 6 is a graph illustrating ultraviolet-visible spectral changes associated with ligand addition to (tetracyanotetraphenylporphyrinato)(cobalt(II)) in accordance with certain embodiments of the present disclosure.

FIG. 7A is a graph illustrating an infrared spectrum of nickel porphyrin in accordance with certain embodiments of the present disclosure.

FIG. 7B is a graph illustrating an infrared spectrum of free-base porphyrin in accordance with certain embodiments of the present disclosure.

FIG. 8 is a graph illustrating cyclic voltammograms of (tetracyanotetraphenylporphyrinato)(cobalt(II)) in accordance with certain embodiments of the present disclosure.

FIG. 9 is a graph illustrating ultraviolet-visible spectral changes associated with the reduction of (tetracyanotetraphenylporphyrinato)(cobalt(II)) in accordance with certain embodiments of the present disclosure.

FIG. 10 is a diagram showing an illustrative logging while drilling environment, according to aspects of the present disclosure.

FIG. 11 is a diagram showing an illustrative wireline logging environment, according to aspects of the present disclosure.

FIG. 12 is a process flow diagram illustrating a method for detecting porphyrins in a wellbore environment in accordance with certain embodiments of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

The terms “couple” or “couples” as used herein are intended to mean either an indirect or a direct connection. Thus, if a first device couples to a second device, that connection may be through a direct connection, or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The present disclosure relates to methods and systems for detection of porphyrins in a wellbore. Particularly, the present disclosure relates to methods and systems for the use of a thin-layer spectroelectrochemical cell to detect porphyrins in a wellbore environment.

More specifically, the present disclosure provides methods and systems for detecting at least one compound selected from the group consisting of: a porphyrin, a metalloporphyrin, a porphyrin derivative, a metalloporphyrin derivative, a porphyrin-like macrocycle, and any combination thereof in at least a portion of a downhole fluid. In certain embodiments, the present disclosure provides a method comprising: positioning a spectroelectrochemical cell in a wellbore penetrating at least a portion of a subterranean formation comprising a downhole fluid; allowing at least a portion of the downhole fluid to flow into the spectroelectrochemical cell; and detecting at least one compound in at least a portion of the downhole fluid, wherein the at least one compound is selected from the group consisting of: a porphyrin, a metalloporphyrin, a porphyrin derivative, a metalloporphyrin derivative, a porphyrin-like macrocycle, and any combination thereof.

In certain embodiments, the present disclosure provides a system comprising: a spectroelectrochemical cell capable of being located in a wellbore penetrating at least a portion of a subterranean formation comprising a downhole fluid, wherein the spectroelectrochemical cell is capable of detecting at least one compound selected from the group consisting of: a porphyrin, a metalloporphyrin, a porphyrin derivative, a metalloporphyrin derivative, a porphyrin-like macrocycle, and any combination thereof; and a receiver coupled to the spectroelectrochemical cell, the receiver capable of receiving one or more detection signals from the spectroelectrochemical cell.

Among the many potential advantages of the methods and systems of the present disclosure, only some of which are alluded to herein, the methods and systems of the present disclosure may provide early detection of porphyrins in a wellbore environment. Porphyrin detection with a thin-layer spectroelectrochemical cell may require significantly less sample fluid than an assay. This smaller fluid volume may be gathered in an open hole or cased hole during any stage of wellbore operations. Thus, porphyrin detection via a spectroelectrochemical cell may occur significantly earlier than detection by assay, allowing time to account for potential downstream issues.

Another advantage of the methods and systems of the present disclosure is real time or near-real time in situ detection. Traditional porphyrin detection involves removing a sample from the wellbore and transporting it to a lab for analysis. In contrast, the methods and systems of the present disclosure provide detection in the wellbore, reducing the risk of sample contamination or degradation. Additionally, in situ detection may allow for detection in multiple regions of the subterranean formation and over multiple stages of the wellbore operation.

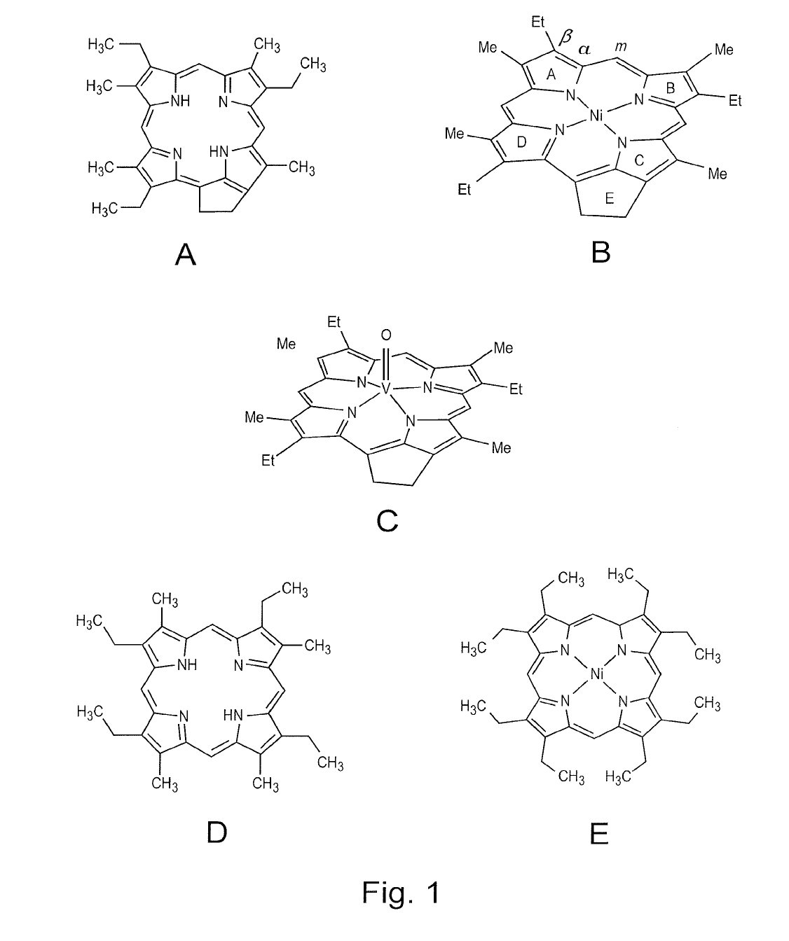

As used herein, the term “porphyrins” refers to heterocyclic macrocycle organic compounds composed of four modified pyrrole subunits interconnected at their alpha-carbon atoms via methane (═CH—) bridges, and derivatives of such compounds. In certain embodiments, derivatives of porphyrins include, but are not limited to metalloporphyrins and metalloporphyrin derivatives. Porphyrins may possess, among other things, excellent electro-optical properties and fluorescence alteration (or switching). Examples of porphyrins that may be suitable for use in the present disclosure include, but are not limited to a porphine, pyropheophorbide-a, pheophorbide, chlorin e6, purpurinimide, octatethylporphyrin, tetrakis(oaminophenyl) porphyrin, meso-tetraphenylporphyrin, tetra phenyl porphyrin, tetra fluoro chloro phenyl porphyrin, tetra dichloro phenyl porphyrin, deoxophylloerythroetioporphyrins (“DPEP”), etioporphyrins, cycloalkanoporphryins, and the like, and any combination thereof. Deoxophylloerytluoetioporphyrins and etioporphyrins are generic terms for two major series of porphyrins in petroleum, named by the number of exocyclic rings in the structure. DPEP may comprise one exocyclic ring and etioporphyrins may comprise none. For example, FIG. 1 shows generic derivatives of a deoxophylloerythroetioporphyrin A and an etioporphyrin D.

Metalloporphyrins are formed by the combination of a free-base porphyrin with a metal ion. Any porphyrin capable of chemically interacting (e.g., binding) with a metal ion may be used in accordance with the present disclosure, including each of the porphyrins previously mentioned. Metalloporphyrins may be concentrated in resins and heavy oils. Suitable metal ions for metalloporphyrins may include, but are not limited to iron(II), iron(III), chromium(II), chromium(III), cobalt(II), cobalt(III), copper(II), lead(II), lead(IV), mercury(I), mercury(II), tin(II), tin(IV), cadmium, zinc, gold(III), gallium (III), manganese(II), manganese(III), manganese(IV), aluminum, nickel(II), nickel(III), antimony(II), antimony(V), vanadium, vanadyl, and the like, and any combination thereof. Examples of metalloporphyrins suitable for embodiments of the present disclosure include, but are not limited to (tetracyanotetraphenylporphyrinato)cobalt(II) (“((CN)₄TPP)Co”), octaethylporphyrin copper, tetrakis(2,6-difluorophenyl)porphyrinato iron, and the like, and any combination thereof. For example, FIG. 1 shows generic derivatives of a DPEP metalloporphyrin B, C and an etiometalloporphyrin E.

In certain embodiments, the methods and systems of the present disclosure may comprise detecting porphyrin-like macrocycles. Examples of porphyrin-like macrocycles suitable for certain embodiments of the present disclosure include, but are not limited to corrins, corroles, chlorins, bacteriochlorins, phthalocyanines, and the like, and derivatives thereof. As used here, “corrins” refers to heterocyclic macrocycles similar to porphyrins with four pyrrole subunits, but lacking one of the carbon groups that link the pyrrole subunits in porphyrins. Corrins may not be fully conjugated around the entire ring. Corroles are fully conjugated derivatives of corrins.

As used herein, “chlorins” refers to large heterocyclic aromatic macrocycles comprising three pyrrole subunits and one pyrroline subunit coupled by four methine linkages. Bacteriochlorins are compounds related to chlorins comprising two pyrrole subunits and two pyrroline subunits. As used herein, “phthalocyanines” refers to compounds having the general formula:

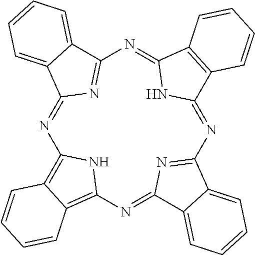

and derivatives thereof.

In certain embodiments, porphyrins, metalloporphyrins, and porphyrin-like macrocycles may comprise ligands. In some embodiments, ligands bind to the central metal of metalloporphyrins. Examples of ligands suitable for certain embodiments of the present disclosure include, but are not limited to oxygen, dioxygen, carbon monoxide, pyridine, chloride, fluoride, nitric oxide, tris(2-pyridylmethyl)amnine, acetonitrile, other small molecules, and any combination thereof.

In certain embodiments, the methods and systems of the present disclosure comprise a spectroelectrochemical cell. In some embodiments, the spectroelectrochemical cell is a thin-layer spectroelectrochemical cell. In certain embodiments, the spectroelectrochemical cell is capable of being located in a wellbore. In some embodiments, the spectroelectrochemical cell may comprise a source of electromagnetic radiation and a detector.

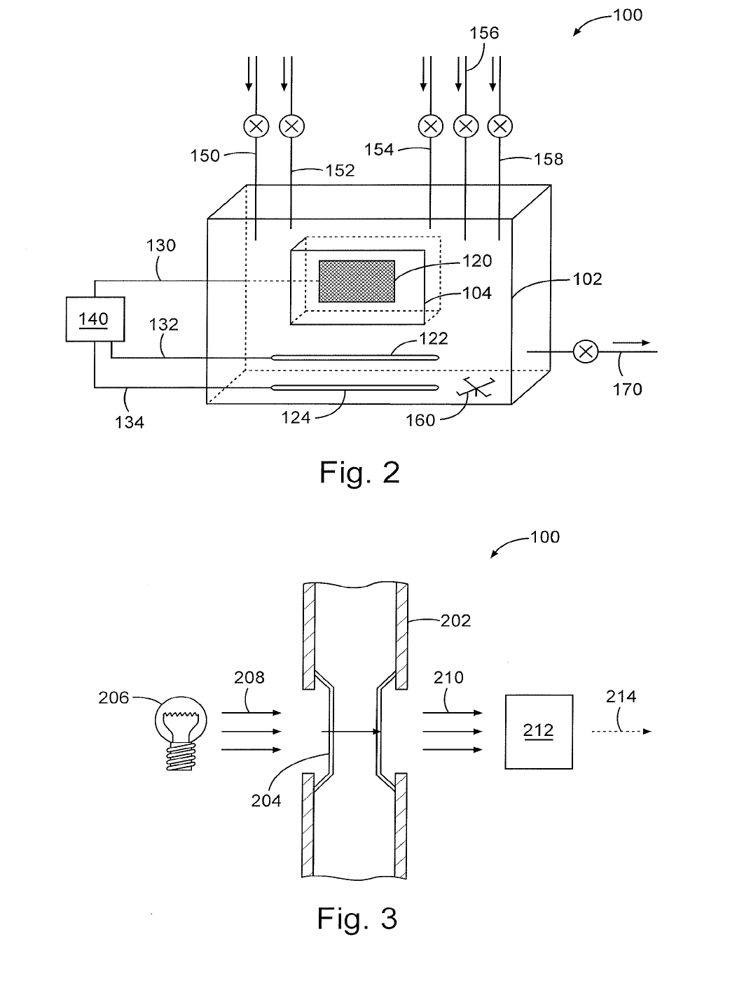

In some embodiments, the spectroelectrochemical cell of the present disclosure may be a thin-layer spectroelectrochemical cell 100 as depicted in FIG. 2. As shown, the thin-layer spectroelectrochemical cell 100, alternatively referred to herein simply as “cell 100,” comprises a cell body 102 that is hermetically sealed and has a first volume. As depicted, the cell body 102 is depicted as a cube or rectangular prism, any shape having a volume and allowing a transparent sample window 104 to be defined therein may be suitable, without departing from the scope of the present disclosure. Generally, the shape of the cell body 102 may be such that the cell body 102 has a base that can balance the cell body 102 while in operation, which may permit it to better be used in downhole tools, as discussed in detail below. The shape of the cell body 102 may be symmetrical about two axes; and may include, but is not limited to, a cube, a cuboid, a cylinder, a hexagonal prism, a triangular prism, and the like. However, bilateral symmetrical shapes may also be used for forming the cell body 102 without departing from the scope of the present disclosure including, but not limited to, a cone, a square-based pyramid, a rectangle-based pyramid, a triangular-based pyramid, and the like. Similarly, asymmetrical shapes or shapes that do not have a base may be selected for the cell body 102.

In some embodiments, the cell body 102 may be made of a material capable of withstanding elevated temperatures and pressures, commonly encountered in a downhole environment. That is, at elevated temperatures and pressures, the cell body 102 remains intact and does not substantially experience structural compromise over time during a subterranean formation operation. In other embodiments, the cell body 102 may be pressure balanced such that the elevated temperatures and pressures experienced by the cell body 102 in a downhole environment are substantially eliminated.

In some embodiments, the cell body 102 may be composed of a material selected from the group consisting of poly(ether ketone), poly(ether ether ketone), poly(ether ketone ketone), poly(ether ether ketone ketone), poly(ether ketone ether ketone ketone), poly(methyl methacrylate), polyethylene, polypropylene, polystyrene, polyvinyl chloride, polytetrafluoroethylene, polycarbonate, polybenzimidazole, a corrosion resistant metal (e.g., titanium, titanium alloy, zirconium, niobium alloy, nickel, nickel alloy), a metal alloy (e.g., titanium alloy), a superalloy (e.g., INCONEL®, a family of austenitic nickel-chromium-based superalloys available from Special Metals Corp. of New Hartford, N.Y.), and any combination thereof. In some embodiments, a corrosion resistant metal, a metal alloy, or a super alloy may be preferred for forming the cell body 102. In some embodiments, a titanium, a titanium alloy, or INCONEL® may be preferred for forming the cell body 102.

In some embodiments, the volume of the cell body 102 may be in the range of a lower limit of about 0.02 milliliters (ml), 0.05 ml, 0.1 ml, 0.25 ml, 0.5 ml, 0.75 ml, 1 ml, 2.5 ml, 5 ml, 10 ml, 50 ml, 100 ml, 250 ml, 500 ml, 750 ml, 1000 ml, 1250 ml, 1500 ml, 1750 ml, 2000 ml, 2250 ml, and 2500 ml to an upper limit of about 5000 ml, 4750 ml, 4500 ml, 4250 ml, 4000 ml, 3750 ml, 3500 ml, 3250 ml, 3000 ml, 2750 ml, and 2500 ml, encompassing any value and subset therebetween.

A transparent sample window 104 is defined in the cell body 102 and in fluid communication therewith (e.g., using an o-ring seal). The transparent sample window 104 defines an optical path through the cell body 102. As used herein, the term “optical path” refers to the path that electromagnetic radiation takes to traverse a distance, and in this case, at least the distance through the cell body 102 defining the transparent sample window 104. The transparent sample window 104 may be composed of a variety of transparent rigid or semi-rigid materials that are configured to allow transmission of electromagnetic radiation therethrough at the wavelength of interest. In some embodiments, the material forming the transparent sample window 104 may be composed of a material including, but not limited to, glass, quartz, sapphire, fused quartz, aluminum oxide, and any combination thereof. The sample window 104 may be in any three-dimensional form, such as a cube, a rod, a disk, a prism, a cone, a cylinder, a fiber (e.g., a very narrow cylinder), or the like.

The transparent sample window 104 has a second volume that is substantially smaller than that of the cell body 102. The shape of the transparent sample window 104 is non-limiting and may include any shape discussed above with reference to the cell body 102, without departing from the scope of the present disclosure, provided that the transparent sample window is able to hold a volume of fluid and permit the transmission of electromagnetic radiation therethrough, as discussed in greater detail below. In some embodiments, the volume of the transparent sample window 104 may be in the range of a lower limit of about 0.01 ml, 0.02 ml, 0.05 ml, 0.1 ml, 0.15 ml, 0.2 ml, 0.25 ml, 0.3 ml, 0.35 ml, 0.4 ml, 0.45 ml, and 0.5 ml to an upper limit of about 1 ml, 0.95 ml, 0.9 ml, 0.85 ml, 0.8 ml, 0.75 ml, 0.7 ml, 0.65 ml, 0.6 ml, 0.55 ml, and 0.5 ml, encompassing any value and subset therebetween.

The fluid that enters into the transparent sample window 104 (e.g., formation fluid or other fluid, such as introduced downhole fluid) may be subjected to spectroelectrochemical analysis, as discussed in greater detail below. The fluid in the cell body 102 and the fluid in the transparent sample window 104 is substantially identical, although only the fluid in the transparent sample window 104 is subjected to a voltage potential. The voltage potential, discussed in greater detail below, drives electrochemical reactions that indicate the relative oxidized or reduced state of species within the fluids.

The location of the transparent sample window 104, although shown substantially in a central location within the cell body 102 may, without departing from the scope of the present disclosure, be located at any position in fluid communication with the cell body 102, provided that the fluid from the cell body 102 is able to enter and leave the transparent sample window 104 when the fluid in the cell body 102 is mixed, as discussed in greater detail below. For example, the transparent sample window 104 may be located to the left or right of the center point of the cell body 102, including abutting the side edge of the cell body 102. Moreover, the transparent sample window 104 may be located above or below the center point of the cell body 102, including abutting the bottom edge of the cell body 102.

The cell 100 comprises working electrode 120 extending through the cell body 102 and into the transparent sample window 104 that is hermetically sealed therethrough, a counter electrode 122 extending through the cell body 102 that is hermetically sealed therethrough, and a reference electrode 124 extending through the cell body 102 that is hermetically sealed therethrough. Each of the electrodes 120, 122, and 124 is so configured to permit a voltage potential to be formed across the transparent sample window 104, while the remaining fluid in the cell body 102 remains neutral.

In some embodiments, the working electrode 120, counter electrode 122, and reference electrode 124 (collectively “electrodes”) may be electrically coupled to a first end of a working electrical wire lead 130, counter electrical wire lead 132, and reference electrical wire lead 134 (collectively “electrical wire leads”), respectively. The electrodes and electrical wire leads may extend through the cell body 102 and, in the case of the working electrode 120, the transparent sample window 104, and be hermetically sealed using any of the methods discussed previously with reference to the cell body 102 (e.g., o-rings, welding components, an epoxy), without departing from the scope of the present disclosure. In some embodiments, the electrodes and the electrical wire leads may be positioned in a tube (not shown) that extends through the cell body 102 and which may abut or extend into the transparent sample window 104. The tube may form hermetic seals by threading through the cell body 102 and transparent sample window 104, where o-rings or other sealing mechanisms may be used to provide an airtight seal between the tube and the cell body 102.

The configuration of the working electrode 120, counter electrode 122, and reference electrode 124 relative to one another in the cell 100 is not limiting. As depicted, the working electrode 120 is positioned through the cell body 102 and into the transparent sample window 104 at a location above the counter electrode 122 and reference electrode 124, which themselves are substantially parallel. However, any other configuration may be suitable for embodiments of the present disclosure, provided that the working electrode 120 is wholly or substantially located within the transparent sample window 104 and the counter electrode 122 and reference electrode 124 are located within the cell body 102. For example, the counter electrode 122 and working electrode 124 may be located above or below each other, on the same or different edges (e.g., side, bottom, top) of the cell body 102 relative to each other, above or below the working electrode 120 together, separately above and below the working electrode 120 (e.g., one above and one below), together on the same edge of the cell body 102 relative to the working electrode 120, separately on different edges of the cell body 102 relative to the working electrode 120, and the like.

The electrical wire leads of each of the electrodes described herein may extend from the cell body 102 and electrically connect on a second end (the end opposite of the end connected to the electrodes) to a potentiostat 140. The potentiostat 140 may be used to establish and maintain a constant voltage potential between the working electrode 120 and the reference electrode 124, such that current flows between the working electrode 120 and the counter electrode 122. The potentiostat 140 may comprise a voltage source and a voltage detector. The particular voltage potential selected may depend on the requirements of the particular operation including, but not limited to, the type of sample, detection species, and the like.

With reference to the working electrode 120, a “working electrode” is the electrode in an electrochemical system on which the reaction of interest occurs (e.g., reduction and oxidation of species). In certain embodiments, as depicted in FIG. 2, the working electrode 120 may be in a middle position in the transparent sample window and may be a mesh electrode electrically coupled to the end of a working electrical wire lead 130. It is understood, however, that the working electrode 120 may be other types of electrodes including, but not limited to, an ultra-microelectrode, a rotating disk electrode, a rotating ring-disk electrode, a hanging mercury drop electrode, a dropping mercury electrode, a wire electrode, a metal film electrode, a structured metal thin film electrode, and the like, without departing from the scope of the present disclosure.

The working electrical wire lead 130 may be connected to the working electrode 120 by any means suitable for providing electrical communication between the working electrical wire lead 130 and the working electrode 120. In some embodiments, the working electrical wire lead 130 may be insulated by a sheath material. The sheath provides insulation such that internal electric charges do not flow freely, making it difficult to conduct an electric current under the influence of an electric field. The sheath may also confer resistance to exposure to heat, light, erosion, corrosion, and the like. Suitable materials forming a sheath for insulating the working electrical wire lead 130 may include, but are not limited to, rubber, vulcanized rubber, polyvinyl chloride, poly(ether ether ketone), and the like, and any combination thereof.

Because the working electrode 120 is the electrode on which the reaction of interest occurs, as discussed previously, the working electrode 120 is wholly within the transparent sample window 104 (e.g., in the middle of the transparent sample window 104, as depicted). Generally, the working electrode 120 may cover at least about 60% of the area of the transparent sample window 104 through which electromagnetic radiation will pass through. In some embodiments, a portion of the working electrical wire lead 130 may also extend into the transparent sample window 104 through the cell body 102.

Referring now to the counter electrode 122, the counter electrode 122 serves as a conductor to complete the circuit in the cell 100. That is, the counter electrode 122, along with the working electrode 120, provides a circuit over which current is either applied or measured. Generally, the potential of the counter electrode 122 is not measured but is adjusted to balance the reaction occurring on the surface of the working electrode 120. Accordingly, the potential of the working electrode 120 can be measured against the reference electrode 124 without compromising the stability of the reference electrode 124 by passing current over it. Like the working electrode 120, the counter electrode 122 is electrically coupled to the end of a counter electrical wire lead 132. The counter electrical wire lead 132 may be configured identical to the working electrical wire lead 130, or by any suitable means or material discussed with reference to the working electrical wire lead 130, including composition material, insulation, insulation material (e.g., a sheath), electrical wire lead connection, and the like, without departing from the scope of the present disclosure. The working electrode 120 and the counter electrode 122 may have electrical wire leads 130 and 132, respectively, that arc identical in all respects (e.g., of the same material, insulated identically, and the like), in only some respects (e.g., of the same material, but insulated differently, or vice versa, and the like), or in no respects (e.g., of different material, and insulated differently, and the like), as described above, without departing from the scope of the present disclosure.

Also, similar to the working electrode 120, the counter electrode 122 may be composed of any of the electrochemically inert materials discussed above with reference to the working electrode 120. In some embodiments, the working electrode 120 and the counter electrode 122 may comprise identical material or different material, without departing from the scope of the present disclosure. Likewise, the type of counter electrode 122 may be any type discussed with reference to the working electrode 120 (e.g., a disk electrode, a rotating disk electrode, a rotating ring-disk electrode).

The reference electrode 124 has a stable and known electrical potential, and may be used to measure the working electrode potential. The reference electrode 124, like the working electrode 120 and counter electrode 122, is electrically coupled to a reference electrical wire lead 134 that may be configured and made identical to one or both of the working electrical wire lead 130 or the counter electrical wire lead 132, or by any suitable means or material discussed with reference to the working electrical wire lead 130 and counter electrical wire lead 132, including composition material, insulation, insulation material (e.g., a sheath), electrical wire lead connection, and the like, without departing from the of the present disclosure. The working electrode 120, the counter electrode 122, and the reference counter electrode may have electrical wire leads 130, 132, and 134, respectively, that are identical in all respects (e.g., of the same material, insulated identically, and the like), in only some respects (e.g., of the same material, but insulated differently, or vice versa, and the like), or in no respects (e.g., of different material, and insulated differently, and the like), as described above, without departing from the scope of the present disclosure.

Because the reference electrode 124 should maintain a stable and known electrical potential, it may be made of materials that combat against drift in the electrical potential. Such electrical potential drift may result in quantitative and/or qualitative errors in data collection related to the fluid species being analyzed in the cell 100. The reference electrode 124 of the present disclosure may be an electrode including, but not limited to, an aqueous reference electrode (e.g., a standard hydrogen electrode, a normal hydrogen electrode, a reversible hydrogen electrode, a saturated calomel electrode, a copper-copper(II) sulfate electrode, a silver chloride electrode, a pH electrode, a palladium-hydrogen electrode, a dynamic hydrogen electrode, and the like), a non-aqueous reference electrode (e.g., a silver-silver chloride electrode, a quasi-reference electrode, a silver-silver nitrate electrode), a pseudo-reference electrode (e.g., a silver-silver ion pseudo-reference electrode), a platinum wire electrode, and the like. The shape of the reference electrode 124 may be any shape suitable for forming the suitable reference electrodes discussed herein, including wire shape, disk shaped, mesh shaped, and the like, without departing from the scope of the present disclosure.

In some embodiments, the working electrode 120, counter electrode 122, and/or reference electrode 124 may be at least partially coated with a functional coating. The functional coating may enhance properties of the electrodes such as by, for example, functioning as a binding species for a sample or detection species. In certain embodiments, for example, a functional coating suitable for embodiments of the present disclosure may comprise gold nano-particles.

The cell body 102 may include a fluid mixer 160. The fluid mixer may he located in the cell body to recirculated fluid placed therein, as discussed in more detail below. In some embodiments, the fluid mixer may be used to recirculate the fluid in the cell body 102 and the transparent sample window 104 such that fresh transparent sample window fluid enters into the transparent sample window 104 for further testing and analysis. In such a way, multiple tests may be run on a variety of fresh fluid samples in the transparent sample window 104 on a single fluid combination without having to remove any fluid from the cell 100. Although a single fluid mixer 160 is shown in FIG. 2, more than one fluid mixer 160, as well as more than one type of fluid mixer 160, may be included in the cell body 102. The inclusion of multiple fluid mixers 160 may be beneficial in embodiments if the volume of the cell body 102 is large and circulation of the fluid therein is more difficult as compared to a smaller volume cell body 102.

The cell body 102 may comprise a plurality of inlets (150, 152, 154, 156, and 158) for introducing fluids into the cell body 102 and the transparent sample window 104. Each inlet, discussed separately below, may extend through the cell body 102 for introducing fluids therethrough. The inlets are each hermetically sealed with reference to the cell body 102 by any means discussed above with reference to the electrodes and electrical wire leads. The inlets may also be formed as tubulars (e.g., flexible or inflexible tubulars) that receive fluids directly from a source, which may be at a downhole location or affixed to a downhole tool such that formation fluid, for example, is directly input into the cell body 102 from the downhole tool. In certain embodiments, where, for example, the inlets are connected to a tubular or another equipment piece for introducing fluids therethrough, the entirety of the inlet and any associated connections may be hermetically sealed or sealable to ensure an airtight configuration of the cell body 102.

As depicted in FIG. 2, the fluid inlets are located on a top portion of the cell body 102. However, they may extend through the cell body 102 at any location (e.g., sides or bottom of the cell body 102) provided that they are able to introduce a volume of fluid into the cell body 102 and the transparent sample window 104, without departing from the scope of the present disclosure. For example, the fluid inlets may have a backstop valve capable of allowing the fluid inlets to introduce fluid into the cell body 102 and transparent sample window 104 even when the fluid inlet is located below a filled volume of the cell body 102.

Similar to the fluid inlets for introducing fluids into the cell body 102 and the transparent sample window 104, the cell body may comprise one or more (one shown) fluid outlet(s) 170 extending through the cell body 102 for removing the fluids from the cell body 102 and transparent sample window 104. The fluid outlet 170 may be hermetically sealed with reference to the cell body 102 by any means discussed above with reference to the electrodes and electrical wire leads. The fluid outlet 170 may be located at any location (e.g., top, side, bottom) of the cell body 102, although it is depicted on the side of the cell body 102 in FIG. 2. Fluid may be removed from the cell 100 through the fluid outlet 170 by any means including, but not limited to, gravity, suction (e.g., pulling a vacuum), and the like, and any combination thereof. In some embodiments, the fluid outlet 170 may be formed as a tubular (e.g., a flexible or inflexible tubular) that allows fluids to be removed from the cell 100. Such tubulars may be connected to a source that aids in the removal of the fluid, such as a suction device (e.g., vacuum). Where the inlets are connected to a tubular or another device for removing fluids therethrough, the entirety of the fluid outlet 170 and any associated connections is preferably hermetically sealed or sealable to ensure an airtight configuration of the cell body 102.

Referring back to the fluid inlets in FIG. 2, the cell 100 may include a sample inlet 150 through which a sample to be tested is initially introduced into the cell body 102. In some embodiments, when the cell 100 is used in a downhole environment, the sample introduced through the sample inlet 150 may be formation fluid, fluid otherwise introduced into the formation, or a combination thereof. Other sample fluids may also be tested using the cell 100 of the present disclosure to identify the presence or absence of a particular species in the sample fluid.

A solvent inlet 152 may extend through the cell body 102 through which an electrolytic solvent may be included into the cell body 102. The solvent, in conjunction with a supporting electrolyte which may be introduced through an electrolyte inlet 154, may facilitate electrochemical reactions in the transparent sample window 104 upon applying a voltage potential therethrough. The use of a dual solvent and supporting electrolyte fluid in the cell 100 may facilitate adjustments to be made, such as adjustments to the amount of electrolyte included, which may be step-wise increased during analysis of one or more sample fluids, for example. As used herein, the term “supporting electrolyte” (or simply “electrolyte” herein) refers an electrolyte solution comprising constituents that are not electroactive in the range of applied potentials being studied, and with an ionic strength (and, therefore, contribution to the conductivity) usually much larger than the concentration of an electroactive substance to be dissolved in it.

FIG. 3 depicts a block diagram non-mechanistically illustrating how spectroelectrochemical evaluation of a sample is achieved using the thin-layer spectroelectrochemical cell according to one or more embodiments of the present disclosure. A thin-layer spectroelectrochemical cell 200 (“cell 200”) may be substantially similar to the cell 100 of FIG. 2. As shown, the cell 200 has a cell body 202 and a transparent sample window 204. Through the fluid inlets (FIG. 2), a conductive fluid, a detection species, and a sample of interest may be introduced into the cell body 202, wherein a portion of the conductive fluid, the detection species, and the sample of interest enter into the transparent sample window 204. This may be achieved by filling the various fluids above the transparent sample window 204 or by mixing using the fluid mixer 160 (FIG. 2), or other means, such as natural or manmade (e.g., as a result of a formation operation) vibrations in a downhole environment. The combination of conductive fluid, the detection species, and the sample in the transparent sample window 204 is referred to herein as “transparent sample window fluid.” The transparent sample window fluid is the fluid whose spectra and electrochemical behavior is evaluated to determine a characteristic of the sample of interest.

First, a voltage potential may be applied across the transparent sample window 204 using the potentiostat 140 (FIG. 2) connected to the electrical wire leads of the working electrode 120 (FIG. 2), counter electrode 122 (FIG. 2), and the reference electrode 124

(FIG. 2). The applied voltage potential drives an electrochemical reaction between the detection 25 species and the sample in the transparent sample window fluid. The spectra of that electrochemical reaction is collected as described below and indicative of a characteristic of the sample due to the oxidized or reduced spectra of the detection species based on binding or otherwise associating with the sample. The voltage potential may be applied continuously or in a stepwise fashion where the voltage is increased throughout the duration of testing.

An electromagnetic radiation source 206 emits electromagnetic radiation into the optical path defined by the transparent sample window 204 (i.e., through the transparent sample window 204). The electromagnetic radiation source 206 may expose the sample in the transparent sample window to electromagnetic radiation. The electromagnetic radiation source 206 may be, but is not limited to, single-wavelength source, a multi-wavelength source, a full spectrum wavelength source, and any combination thereof. Specific examples of suitable electromagnetic radiation sources 206 may include, but are not limited to, a light bulb, a light emitting device, a laser, a blackbody, a photonic crystal, and any combination thereof. The electromagnetic radiation source 206 produces electromagnetic radiation 208 which may be in the non-limiting form of infrared radiation, near-infrared radiation, visible light, ultraviolet light, and any combination thereof.

The electromagnetic radiation 208 may be emitted from the electromagnetic radiation source 206 and optically interact with the sample fluid to generate modified electromagnetic radiation 210. As used herein, the term “optically interact,” or variations thereof, refers to reflection, transmission, absorption, fluorescence, scattering, and/or diffraction of electromagnetic radiation 210. In some embodiments, the electromagnetic radiation may optically interact with the sample fluid through a transparent sample window 204 in the spectroelectrochemical cell without a voltage potential being applied thereto (e.g., in a non-reduced and/or non-oxidized state). In other embodiments, the electromagnetic radiation 208 may optically interact with the sample fluid through the transparent sample window 204 with a voltage potential being applied thereto, reflecting the spectra and electrochemical behavior (e.g., in a reduced and/or oxidized state) of the sample fluid.

The modified electromagnetic radiation 210 may be received by a detector 212 that generates a detection signal 214 corresponding to a characteristic of the sample of interest (e.g., formation fluid or downhole fluid). The detector 212 may be any device capable of detecting electromagnetic radiation. In some embodiments, the detector 212 may be a photodetector, which, as used herein, includes spectrometers, photometers, integrated computational elements coupled with a photodetector, and the like. In some embodiments, the detector 212 may be capable of detecting the intensity of electromagnetic radiation as a function of wavelength. Specific photodetectors that may be used as or within the detector 212 in the embodiments described herein may include, but are not limited to a silicon photodetector, an InGaAs photodetector, a photomultiplier tube, and the like, and any combination thereof.

As shown, the detector 212 is opposite the electromagnetic radiation source 206. However, in some embodiments, one side of the transparent sample window 204 may be a reflective surface and the detector 212 may be located on the same side of the transparent sample window 204 as the electromagnetic radiation source 206, wherein the emitted electromagnetic radiation 208 transmits through the transparent sample window 204, optically interacts with the fluid therein, reflects off the reflective surface back through the side of the transparent sample window 204 to a detector 212. In such a configuration, only one side of the transparent sample window 204 is transparent. In other embodiments, there may be a single transparent sample window 204 where light interaction with the fluid therein occurs through attenuated total internal reflection.

Referring again to FIG. 3, the detector 212 may generate an detection signal 214 corresponding to a characteristic of the sample of interest. In some embodiments, the detection signal 214 may include, but is not limited to, a voltammetry signal (e.g., cyclic voltammetry, linear sweep voltammetry, staircase voltammetry, squarewave voltammetry, anodic stripping voltammetry, differential pulse voltammetry), an electromagnetic radiation absorption a spectroscopy signal, and any combination thereof.

In some embodiments, the detection signal 214 may be graphically displayed (e.g., as a voltammogram, a spectrogram, a data chart, and the like, and combinations thereof). For example, the detection signal 214 may be conveyed to or otherwise received by a signal processor (not shown) communicably coupled the detector 210. The signal processor may be a computer including a non-transitory machine-readable medium configured to graphically display the output signal 214, corresponding to a characteristic of the sample of interest.

Computer hardware used to graphically display the detection signal 214 may include a processor configured to execute one or more sequences of instructions, programming stances, or code stored on a nontransitory, computer-readable medium. The processor may be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any suitable entity capable of performing calculations or other manipulations of data. In some embodiments, computer hardware may further comprise elements such as, for example, a memory (e.g., random access memory (RAM), flash memory, read only memory (ROM), programmable read only memory (PROM), erasable read only memory (EPROM)), registers, hard disks, removable disks, CD-ROMS, DVDs, or any other suitable storage device or medium.

In some embodiments, the detection signal 214 corresponds to the presence and/or the absence of a species including, but not limited to, a porphyrin, a metalloporphyrin, a porphyrin derivative, a metalloporphyrin derivative, a porphyrin-like macrocycle, or any combination thereof. In some embodiments, the detection signal 214 may correspond to a concentration of one or more species in a sample fluid, thereby enabling an operator to glean information regarding the overall porphyrin content of a particular portion or entire area of a wellbore penetrating a hydrocarbon reservoir or water reservoir. For example, in certain embodiments, the concentration of a porphyrin may be tied to the time it takes for the detection species spectra to change (e.g., indicating an uptake of the analyte of interest). For example, in certain embodiments, the concentration of a porphyrin may be determined according to spectra determined by spectroscopy. For example, in certain embodiments, concentration of a porphyrin may be determined based on voltammetry measurements.

In certain embodiments, detecting porphyrins, metalloporphyrins, or porphyrin-like macrocycles with a spectroelectrochemical cell may comprise spectroscopy. Spectroscopy may comprise exposing a sample to electromagnetic radiation and measuring the radiation or absorption intensity as a function of wavelength or frequency. In certain embodiments, spectroscopy may indicate whether a species is present in the fluid and/or indicate the concentration of the species. Suitable forms of electromagnetic spectroscopy may include ultraviolet-visible (“UV-Vis”) spectroscopy and/or infrared (“IR”) spectroscopy, which may be used to detect a species in a fluid. In certain embodiments, spectra measured by the thin-layer spectroelectrochemical cell may be compared to known spectra to qualitatively and/or quantitatively analyze the presence of porphyrins, metalloporphyrins, or porphyrin-like macrocycles in a downhole fluid sample. In certain embodiments, incorporating a metal ion into a porphyrin to form a metalloporphyrin may result in a spectral shift, which may result in distinguishable IR and UV-Vis spectra.

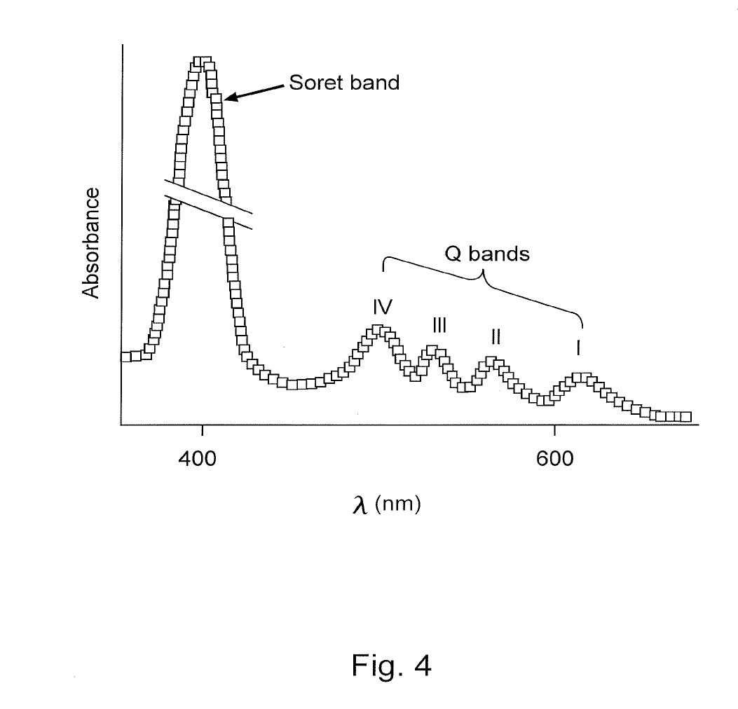

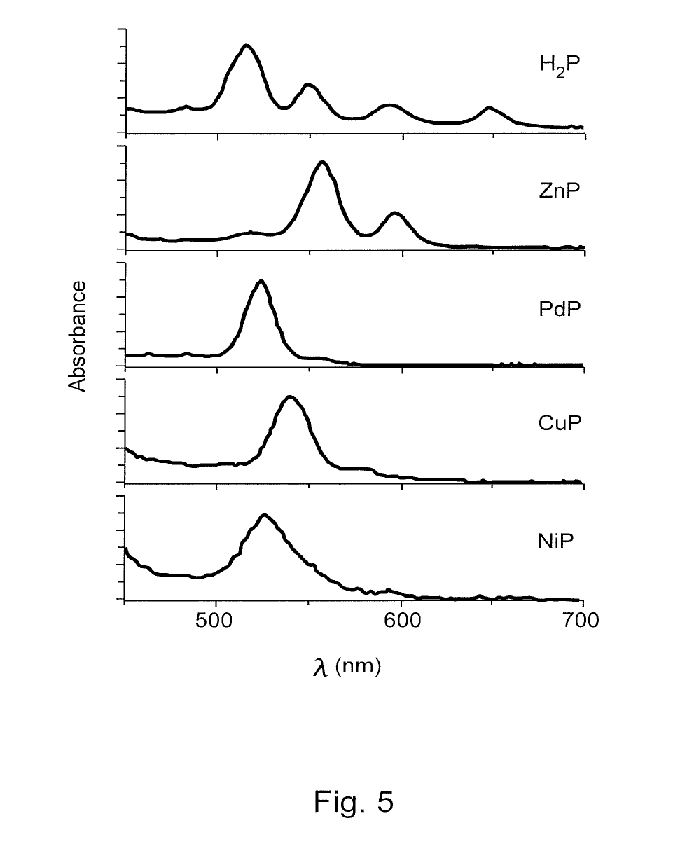

FIG. 4 illustrates a typical UV-Vis spectrum of a porphyrin, which exhibits an intense absorption band—(extinction coefficient greater than 200) often referred to as the “Soret” band—around 400 nm, and several weaker absorption bands referred to as “Q” bands at higher wavelengths. FIG. 5 illustrates a comparison of typical UV-Vis spectra of free-base porphyrin and various metalloporphyrins. When a metal ion is incorporated into free-base porphyrin (H₂P) to form a metalloporphyrin (ZnP, PdP, CuP, NiP), a marked color change may cause a transformation of the UV-Vis spectrum, especially in the Q bands. In some embodiments, a UV-Vis spectrum of a fluid sample may be compared to spectra such as those in FIGS. 4 and 5 to determine the presence of a porphyrin.

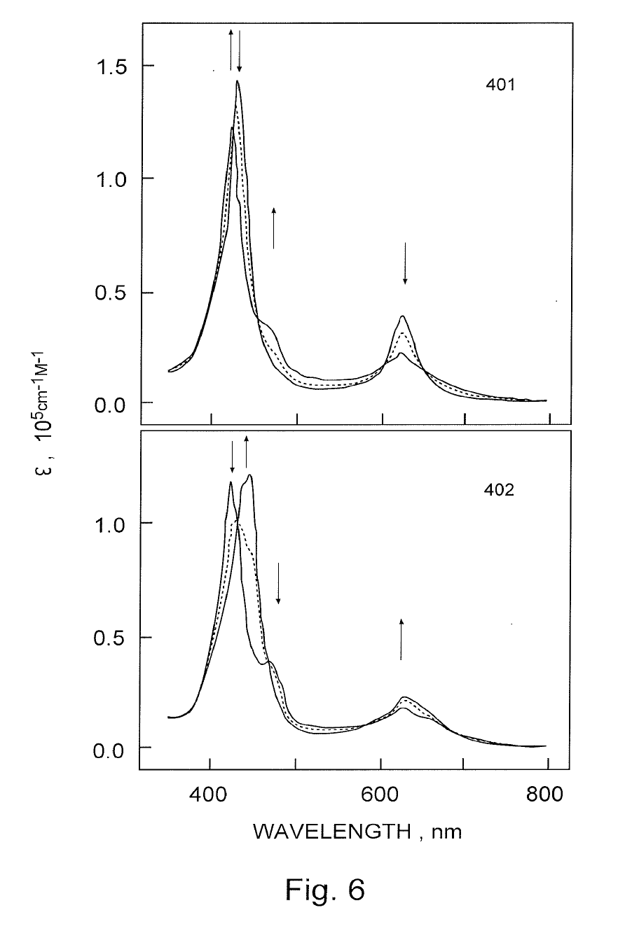

In certain embodiments, a UV-Vis spectrum of a sample may be indicative of the presence of ligands bound to porphyrins. FIG. 6 is a graph illustrating the change in UV-Vis spectra of ((CN)₄TPP)Co during the addition of a first pyridine ligand 401 and a second pyridine ligand 402. The arrows in FIG. 6 denote the shift of each peak during each addition. The spectral shifts in FIG. 6 show that ligand addition may be detected by UV-Vis spectra.

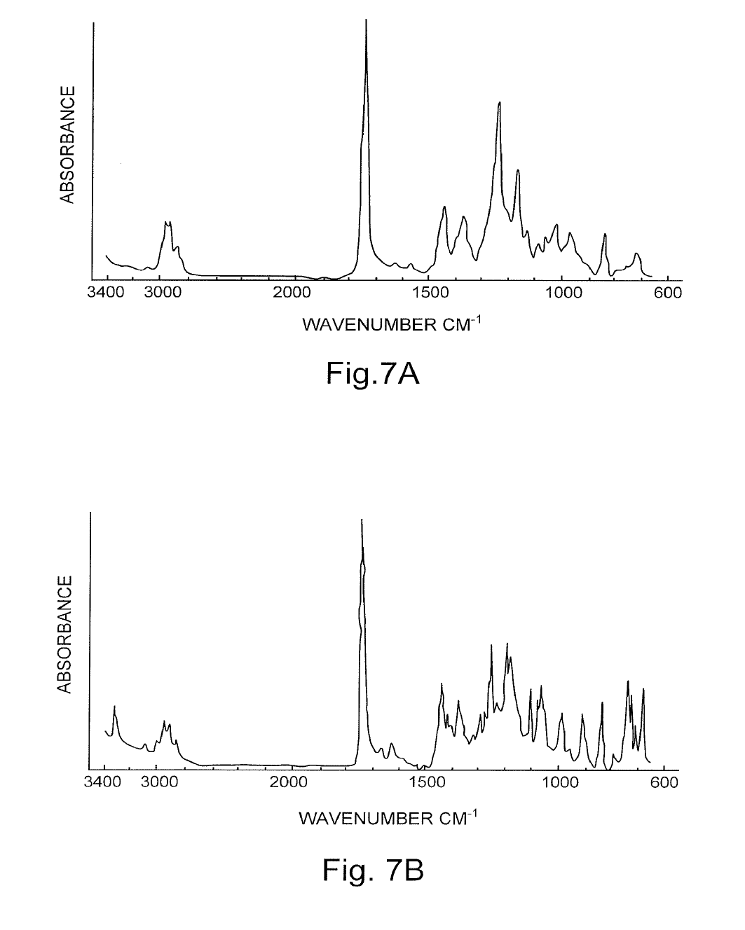

FIGS. 7A and 7B illustrate IR spectra of a nickel-based metalloporphyrin and a free-base porphyrin, respectively. A porphyrin or metalloporphyrin may be detected with IR spectroscopy by comparing the fluid sample spectrum to known spectra such as these. In some embodiments, IR spectra may also be used to determine the concentration of a species in the downhole fluid.

In certain embodiments, the spectroelectrochemical cell may use spectroelectrochemistry to detect species in a fluid. Spectroelectrochemistry couples spectroscopic and electrochemical techniques together to perform measurements and data collection of certain fluids. Specifically, spectroelectrochemistry suitable for embodiments of the present disclosure comprises evaluating spectra which are related individually to the type and concentrations of oxidized and/or reduced species. In certain embodiments, the spectroelectrochemical cell may comprise a solvent and/or electrolyte introduced to facilitate electrochemical reactions in the cell upon the application of a voltage. In certain embodiments, the spectroelectrochemical cell may comprise a detection species.

In certain embodiments, voltammetry may be performed with the spectroelectrochemical cell to detect or quantify a species in the downhole fluid. In some embodiments, voltammetry may comprise detecting the presence or quantity of a species by measuring current and varying voltage potential. Potential may be varied stepwise or continuously. In certain embodiments, a species may be detected by cyclic voltammetry, linear sweep voltammetry, staircase voltammetry, squarewave voltammetry, anodic stripping voltammetry, differential pulse voltammetry, or any combination thereof. In certain embodiments, the spectroelectrochemical cell may be capable of performing voltammetry by varying the potential of an electrode in contact with the downhole fluid sample and measuring the resulting current. In some embodiments, cyclic voltammetry is performed by the spectroelectrochemical cell on a redox reactive sample. A redox reactive sample may comprise a sample that can be reduced or oxidized.

In some embodiments, cyclic voltammetry may comprise starting at an original potential, increasing until a target potential is reached, and then decreasing to return to the original potential. In certain embodiments, the resulting current is measured and plotted against the changing potential to produce a cyclic voltammogram. Free-base porphyrins, metalloporphyrins comprising different metals, and porphyrin-like macrocycles may exhibit different spectroelectrochemical behavior by reducing and/or oxidizing at different potential ranges. This allows for detection of the presence of a species in a sample by comparison of the sample voltammogram with voltammograms of known compounds. FIG. 6 illustrates a cyclic voltammogram of ((CN)₄TPP)Co at a platinum electrode in various solvents with 0.1M tetrabutylammonium perchlorate (“TBAP”) as a supporting electrolyte. The voltammogram shows the resulting current as the potential cycles from the starting potentials 601 to the target potentials 602 and back. The reduction/oxidation occurs around the peaks 603.

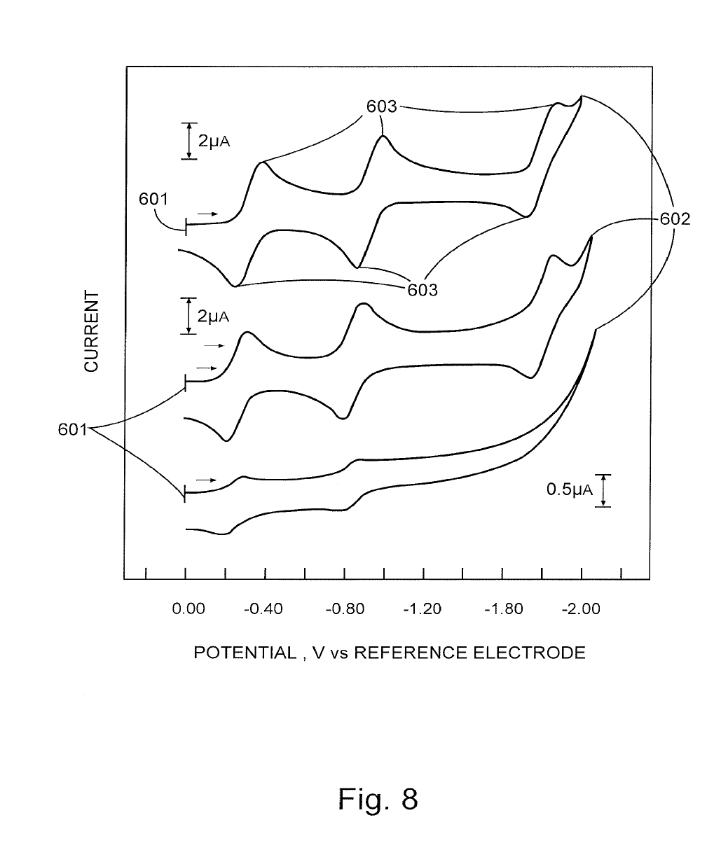

In certain embodiments, the half cell potential (“E^{o}_{1/2}”) may be determined from the cyclic voltammetry measurements. The half cell potential is the potential at which half of the species in the thin-layer are reduced and half are oxidized. In certain embodiments, the half cell potential may be determined from a cyclic voltammogram such as FIG. 8. In some embodiments, the half cell potential of a downhole fluid sample measured by cyclic voltammetry performed in the spectroelectrochemical cell may be indicative of whether a porphyrin, metalloporphyrin, or porphyrin-like macrocycle is present. In some embodiments, the concentration of a porphyrin, metalloporphyrin, or porphyrin-like macrocycle may be determined based on the cyclic voltammograms.

In some embodiments, application of a voltage potential may be in the range of a lower limit of about −3.0 V, −2.75 V, −2.5 V, −2.25 V, −2.0 V, −1.75 V, −1.5 V, −1.25 V, −1.0 V, −0.75 V, −0.5 V, −0.25 V, and 0 V to an upper limit of about +3.0 V, +2.75 V, +2.5 V, +2.25 V, +2.0 V, +1.75 V, +1.5 V, +1.25 V, +1.0 V, +0.75 V, +0.5 V, +0.25 V, and 0 V, encompassing any value and subset therebetween.

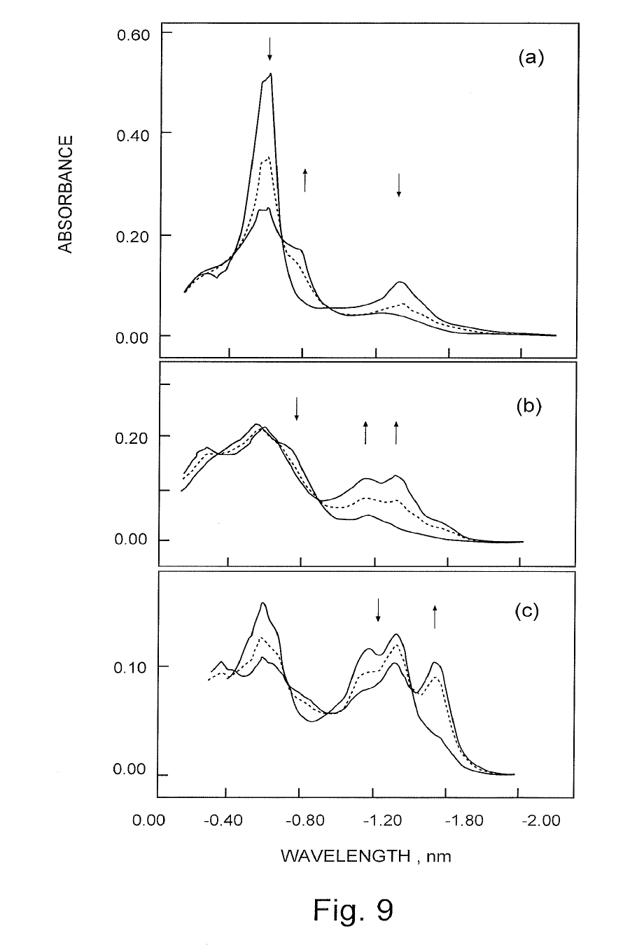

In some embodiments, electromagnetic spectra of the sample may be measured during cyclic voltammetry. In some embodiments, generating electromagnetic spectra may comprise UV-Vis or IR spectroscopy. In certain embodiments, spectroscopy may be performed at the original potential, while the potential changes, at the target potential, and/or after the return to the original potential. In some embodiments, spectroscopy may be performed after each oxidation and/or reduction occurs. FIG. 9 is a graph illustrating UV-Vis spectra associated with the reduction of ((CN)₄TPP)Co in pyridine containing 0.1M TBAP as the potential is changed from an original potential to a target potential. UV-Vis spectra were measured as potential was scanned from −0.13 to −0.56 volts (“V”) (a), scanned from −0.71 to −1.18 V (b), and stepped from −1.18 to −1.96 V (c). The arrows in FIG. 9 denote the change in UV-Vis spectra as the potential changed. In some embodiments, porphyrins, metalloporphyrins, and porphyrin-like macrocycles may reduce or oxidize at different potential ranges, and may accordingly exhibit different spectra over those ranges. In certain embodiments, quantitative and qualitative analysis of porphyrins, metalloporphyrins, and porphyrin-like macrocycles in a sample may be performed based on their differences in oxidation and/or reduction potential and associated spectra.

In certain embodiments, the half cell potential may be sufficient to determine the presence and concentration of a species in a downhole fluid sample. In certain embodiments, the electromagnetic spectra may be sufficient to determine the presence and concentration of a species in a downhole fluid sample. In some embodiments, both the half cell potential and the electromagnetic spectra may be measured to determine the presence and concentration of porphyrins, metalloporphyrins, or porphyrin-like macrocycles in a downhole fluid sample, and compared to confirm the detection and/or quantification.

Use of the thin-layer spectroelectrochemical cell, the potentiostat, the electromagnetic radiation source, and the detector as used herein may permit real-time or substantially real-time identification of the presence or absence of porphyrins, metalloporphyrins, and porphyrin-like macrocycles, including quantitative data. In some embodiments, detection comprises a detection species chemically interacting (e.g., by bonding) with the species and responding with conformational, fluorescent, colorimetric, or other detectable changes that can be detected by a detector of the present disclosure. That is, the electrochemical and spectroscopic properties of the bound and unbound species are different and detectable. Application of a voltage potential across these species further results in a change in their optical properties, resulting in an enhanced optical spectra that is more readily detectable, particularly when a low concentration of the analyte is present.

In some embodiments, the application of a voltage potential across the detection species may change the binding properties of the detection species, to more readily bind to a porphyrin or metalloporphyrin in a sample fluid, thereby increasing the optical signal and improving the detection. Moreover, the change in binding properties may be reversible, such that the porphyrins may be unbound by the detection species when the voltage potential is reversed or otherwise changed. In yet other embodiments, the voltage potential may affect the electrostatic properties of the detection species, such as the location of metal ions in a metalloporphyrin (e.g., whether they are exposed or encompassed in the porphyrin, and the like), for example, which may affects the electromagnetic spectra.

Solvents suitable for use in the spectroelectrochemical cell of the present disclosure may be polar solvents, non-polar solvents, or any combination thereof. Examples of solvents that may be suitable for certain embodiments of the present disclosure include, but are not limited to hexane, benzene, toluene, diethyl ether, chloroform, 1,4-dioxane, ethyl acetate, tetrahydrofuran, hydroxymethylpyrimidine, phthalocyanine, dichloromethane, acetone, acetonitrile, dimethylformamide, dimethyl sulfoxide, acetic acid, nbutanol, t-butyl alcohol, isopropanol, n-propanol, ethanol, methanol, formic acid, water, carbon tetrachloride, chlorobenzene, cyclohexane, 1,2-dichloroethane, butyl lactate, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, methanol, butyl alcohol, d′limonene, fatty acid methyl esters, butylglycidyl ether, 1,2,-dimethoxyethane, heptane, glycerin, hexamethylphosphoramide, hexamethylphosphorous triamide, methyl t-butyl ether, n-methyl-2-pyrrolidinone, nitromethane, pentane, petroleum ether, triethyl amine, pyridine, o-xylene, m-xylene, p-xylene, octanoic acid, propionic acid, and the like, and any combination thereof.

Electrolytes suitable for the present disclosure may comprise an electrolyte solution that is electroinactive in the range of applied potentials relevant to porphyrin and metalloporphyrin detection, and that has an ionic strength much larger than the concentration of porphyrin to be dissolved therein. Examples of electrolytes that may be suitable for certain embodiments of the present disclosure include, but are not limited to lithium chloride, anhydrous lithium chloride, potassium chloride, perchloric acid, sulfuric acid, hydrochloric acid, sodium hydroxide, potassium hydroxide, chloride, hydroxide, citrate, tartrate, oxylate, potassium cyanide, potassium thiocyanate, ethylenediminetetraacetic acid (“EDTA”), lithium perchlorate, sodium perchlorate, tetrabutylammonium perchlorate (“TBAP”), a tetra-alkyl ammonium salt, tetra-ethyl ammonium salt, tetra-n-butyl ammonium salt, a perchlorate ion, any combination thereof, and any other ionic species.

Detection species suitable for the present disclosure may react with the porphyrin or metalloporphyrin in the downhole fluid causing a conformational (e.g., isomers), colorimetric, or other change that can be detected by spectroelectrochemistry or other detection means. The detection species may be present in any amount able to electrochemically react with a sample of interest. In some embodiments, the detection species may be introduced via a fluid inlet (as depicted in FIG. 2). In certain embodiments, the detection species may be coated onto the working electrode, onto the body of the spectroelectrochemical cell, or onto an optically inert film within the body of the cell.

In some embodiments, the thin-layer spectroelectrochemical cell, the potentiostat, the electromagnetic radiation source, and the detector may form a single, enclosed device that may be transported and operated as a single unit. In other embodiments, the thin-layer spectroelectrochemical cell, the potentiostat, the electromagnetic radiation source, and the detector may form separate components to perform the methods described herein. Whether as a single device or as separate components, in some embodiments, the thin-layer spectroelectrochemical cell, the potentiostat, the electromagnetic radiation source, and the detector may be located at a downhole location in a wellbore in a subterranean formation. They may be similarly located in a wellbore during or as part of a subterranean formation operation, or on a downhole tool during performance of a subterranean formation operation such as, for example, a measurement-while-drilling tool, a drill string, a formation tester, a wireline, a drill stem test tool, and any combination thereof. Inclusion of the thin-layer spectroelectrochemical cell, the potentiostat, the electromagnetic radiation source, and the detector as part of these tools may facilitate collection of formation fluid for use as the sample in the methods described herein, such as if the thin-layer spectroelectrochemical cell is integral to a formation tester that is designed to collect formation fluid. In some embodiments, the thin-layer spectroelectrochemical cell, the potentiostat, the electromagnetic radiation source, and the detector, whether as a single device or as separate components, may be coupled to other logging tools, such as various other downhole measurement tools, sensors, LWD/MWD elements, and/or telemetry elements.

In certain embodiments, the thin-layer spectroelectrochemical cell, the potentiostat, the electromagnetic radiation source, and the detector may be located in a pipeline, such as a pipeline comprising a hydrocarbon fluid. In some embodiments, the thin-layer spectroelectrochemical cell, the potentiostat, the electromagnetic radiation source, and the detector may be a compact unit on the surface. In certain embodiments, the compact unit may be used to determine additional surface measurements including, but not limited to analysis of downhole samples that have been recovered to the surface.

Porphyrins, metalloporphyrins, and porphyrin-like macrocycles may be evaluated for their presence and/or absence in a sample before, during, and/or after certain subterranean formation operations have taken place. In certain embodiments, subterranean formation operations may comprise drilling, stimulating (e.g., acidizing or fracturing), measurement-while-drilling (“MWD”), logging-while-drilling (“LWD”), completion, wireline, production, remedial activities, and any other suitable operation. “Measurement-while-drilling” is the term generally used for measuring conditions downhole concerning the movement and location of the drilling assembly while the drilling continues. “Logging-while-drilling” is the term generally used for similar techniques that concentrate more on formation parameter measurement.

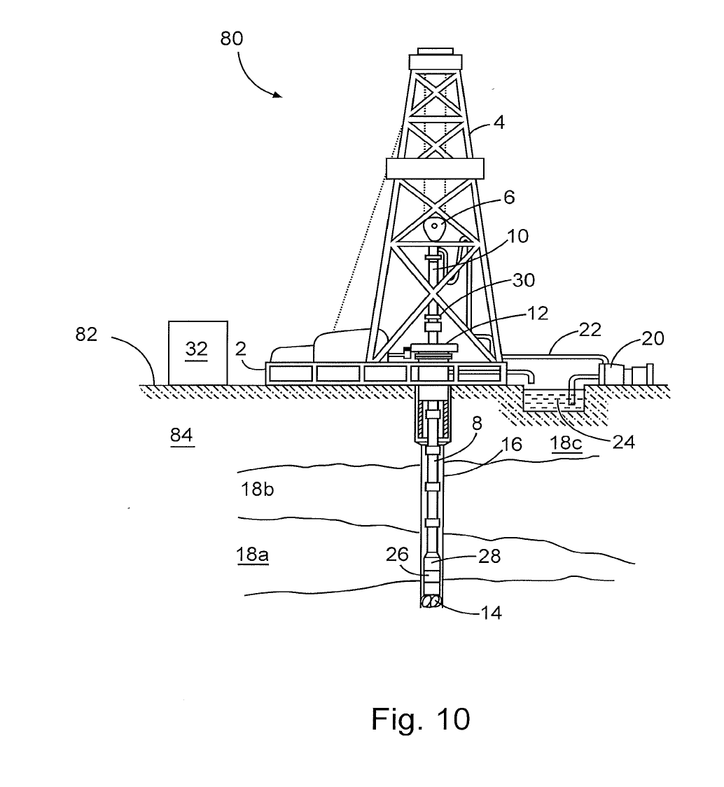

One or more of the systems and/or methods described above may be incorporated into/with a wireline tool/sonde for wireline logging operation or into/with one or more LWD/MWD tools for drilling operations. FIG. 10 is a diagram showing a subterranean drilling system 80 incorporating aspects of the spectroelectrochemical cell systems described above. The drilling system 80 comprises a drilling platform 2 positioned at the surface 82. As depicted, the surface 82 comprises the top of a subterranean formation 84 containing one or more rock strata or layers 18a-c, and the drilling platform 2 may be in contact with the surface 82. In other embodiments, such as in an off-shore drilling operation, the surface 82 may be separated from the drilling platform 2 by a volume of water.

The drilling system 80 comprises a derrick 4 supported by the drilling platform 2 and having a traveling block 6 for raising and lowering a drill string 8. A kelly 10 may support the drill string 8 as it is lowered through a rotary table 12. A drill bit 14 may be coupled to the drill string 8 and driven by a downhole motor and/or rotation of the drill string 8 by the rotary table 12. As bit 14 rotates, it creates a wellbore 16 that passes through one or more rock strata or layers 18. A pump 20 may circulate drilling fluid through a feed pipe 22 to kelly 10, downhole through the interior of drill string 8, through orifices in drill bit 14, back to the surface via the annulus around drill string 8, and into a retention pit 24. The drilling fluid transports cuttings from the wellbore 16 into the pit 24 and aids in maintaining integrity of the wellbore 16.

The drilling system 80 may comprise a bottom hole assembly (“BHA”) coupled to the drill string 8 near the drill bit 14. The BHA may comprise various downhole measurement tools and sensors and LWD and MWD elements 26, including a thin-layer spectroelectrochemical cell that may utilize techniques in accordance with certain embodiments of the present disclosure to detect porphyrins in a downhole fluid. The BHA may also comprise a potentiostat, an electromagnetic radiation (“EM”) source, a detector, and/or other downhole tools. As the bit extends the wellbore 16 through the formations 18, the tools 26 may collect measurements relating to wellbore 16 and the formation 84. The tools and sensors 26 of the BHA be communicably coupled to a downhole telemetry element 28, which may incorporate, for instance, a downhole frequency multiplier, a power source, and a controller to selectively couple the power source to the frequency multiplier. The telemetry element 28 may comprise a mud pulse telemetry system, and acoustic telemetry system, a wired communications system, a wireless communications system, or any other type of communications system that would be appreciated by one of ordinary skill in the art in view of this disclosure. The telemetry element 28 may transfer measurements from LWD/MWD elements 26 to a surface telemetry element 30 and/or to receive commands from the surface telemetry element 30 via a surface control unit 32. The surface telemetry element 30 may comprise, for instance, a receiver, an EM radiation source, an EM radiation detector, and a beam splitter. The surface and downhole telemetry elements 30/28 may cooperate to transfer measurements from the tools 26 to the surface and/or to receive commands from the surface. In certain embodiments, the spectroelectrochemical cell, potentiostat, electromagnetic radiation source, detector, and/or other downhole tools of the subsurface device 180 may be communicably coupled to a telemetry element, and the telemetry element may receive measurements from the spectroelectrochemical cell, potentiostat, electromagnetic radiation source, detector, and/or other downhole tools and transmit telemetry data corresponding to the received measurements to a receiver.

In certain embodiments, the drilling system 80 may comprise a surface control unit 32 positioned at the surface 82. The surface control unit 32 may comprise an information handling system communicably coupled to the surface telemetry element 30 and may receive measurements from the tool 26 and/or transmit commands to the tool 26 though the surface telemetry element 30. The surface control unit 32 may also comprise a receiver to receive measurements from the tool 26 when the tool 26 is retrieved at the surface 82. As is described above, the surface control unit 32 may process some or all of the measurements from the tool 26 to determine certain parameters of downhole elements, including the wellbore 16 and formation 84. In certain embodiments, the surface control unit 32 comprises a receiver that receives a detection signal from a spectroelectrochemical cell.

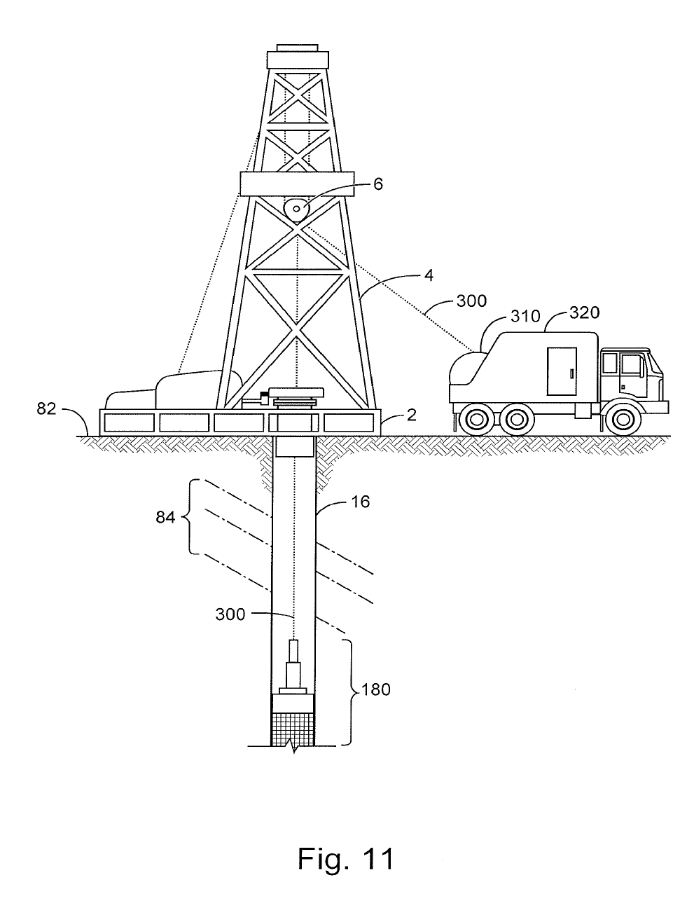

FIG. 11 illustrates oil well equipment being used in an illustrative wellbore environment in accordance with certain embodiments of the present disclosure. A drilling platform 2 supports a derrick 4 having a traveling block 6 for raising and lowering a drill string (not shown). The drill string creates a wellbore 16 that passes through various subterranean formations 84. At various times during the drilling process, the drill string may be removed from the wellbore 16. Once the drill string has been removed, a subsurface device 180 may be lowered downhole to the desired setting depth via a conveying member 300. The subsurface device 180 may be physically and/or communicably coupled to a control unit (not shown) at the surface through a wireline or slickline, or any other conveyance, or through a downhole telemetry system. In some embodiments, the subsurface device 180 may comprise a thin-layer spectroelectrochemical cell that may utilize techniques in accordance with certain embodiments of the present disclosure to detect porphyrins and/or other species in a downhole fluid. In certain embodiments, the subsurface device 180 may also comprise other downhole tools, such as various other downhole measurement tools, sensors, and elements. In certain embodiments, the subsurface device 180 may comprise only the spectroelectrochemical cell, potentiostat, electromagnetic radiation source, and/or detector. The subsurface device 180 may be lowered on the conveying member 300, as illustrated, or may be lowered along a tool string selectively positioned downhole during well completions operations. In some embodiments, the subsurface device 180 may be conveyed through a flow passage in a tubular string or using a wireline, slickline, coiled tubing, downhole robot or the like.

As discussed with respect to FIG. 10, the spectroelectro chemical cell, potentiostat, electromagnetic radiation source, detector, and/or other downhole tools of the subsurface device 180 may be communicably coupled to a telemetry element. The telemetry element may receive measurements from the spectroelectrochemical cell, potentiostat, electromagnetic radiation source, detector, and/or other downhole tools and transmit telemetry data corresponding to the received measurements to a receiver. In some embodiments, the receiver may be part of a logging facility (shown in FIG. 11 as a truck 320, although it may be any other structure), which may collect measurements from the subsurface device 180, and may include computing facilities (including, e.g., a control unit/information handling system) for controlling, processing, storing, and/or visualizing the measurements gathered by the subsurface device 180. In certain embodiments, some or all of the measurements taken at the subsurface device 180 may also be stored within the device 180 or the telemetry element for later retrieval at the surface 82. It should be noted that while FIG. 11 generally depicts the receiver on the surface 82, it could be elsewhere, including, but not limited to various locations in the wellbore 16 or at an offsite, remote location.

In some embodiments, the conveying member 300 may include a slickline or a wireline. Such slicklines/wirelines typically comprise one or more cables running the length of the conveying member 300 and secured within a polymer material surrounded by a protective coating sheath. The conveying member 300 may be unspooled from a spool 310 on a slickline truck 320 onto a sheave (e.g., traveling block 6 or some other sheave) on the drilling platform 2. From here, the conveying member 300 with the subsurface device 180 may be lowered (deployed) into the wellbore 16 and subsequently raised (retracted) from the wellbore 16 after placing the tool string or subsurface device 180 as described above.

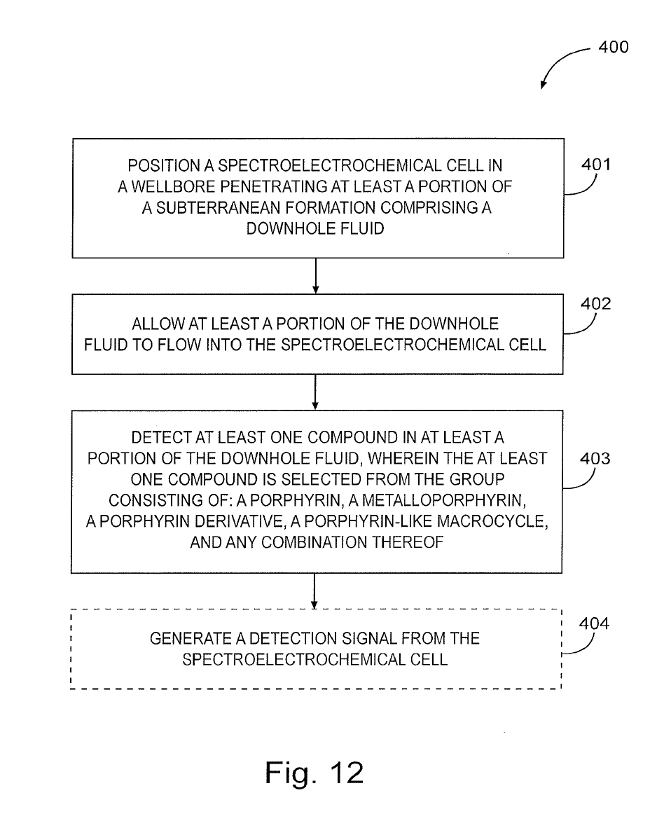

FIG. 12 depicts a process flow 400 for detecting porphyrins in a wellbore environment. The use of arrows in FIG. 12 is not meant to require any particular order in which the methods of the present disclosure must be performed, and any order of performing these steps is contemplated by the present disclosure and claims. In certain embodiments, the process flow 400 may comprise positioning a spectroelectrochemical cell in a wellbore penetrating at least a portion of a subterranean formation comprising a downhole fluid 401, allowing at least a portion of the downhole fluid to flow into the spectroelectrochemical cell 402, and detecting at least one compound in at least a portion of the downhole fluid, wherein the at least one compound is selected from the group consisting of: a porphyrin, a metalloporphyrin, a porphyrin derivative, a porphyrin-like macrocycle, and any combination thereof 403. In some embodiments, the process flow 400 may comprise generating a detection signal from the spectroelectrochemical cell 404.

The downhole fluids of the present disclosure may include a formation fluid, a reservoir fluid, a treatment fluid, or any other fluid in the wellbore or subterranean formation. In some embodiments, the formation fluids of the present disclosure may comprise a hydrocarbon fluid such as oil, gas, or any combination thereof. As used herein, the term “treatment fluid” refers to any fluid that may be used in a subterranean application in conjunction with a desired function and/or for a desired purpose. The term “treatment fluid” does not imply any particular action by the fluid or any component thereof. Illustrative treatment operations can include, for example, fracturing operations, gravel packing operations, acidizing operations, scale dissolution and removal, consolidation operations, and the like.

An embodiment of the present disclosure is a method comprising: positioning a spectroelectrochemical cell in a wellbore penetrating at least a portion of a subterranean formation comprising a downhole fluid; allowing at least a portion of the downhole fluid to flow into the spectroelectrochemical cell; and detecting at least one compound in at least a portion of the downhole fluid, wherein the at least one compound is selected from the group consisting of: a porphyrin, a metalloporphyrin, a porphyrin derivative, a porphyrin-like macrocycle, and any combination thereof.

An embodiment of the present disclosure is a system comprising: a spectroelectrochemical cell capable of being located in a wellbore penetrating at least a portion of a subterranean formation comprising a downhole fluid, wherein the spectroelectrochemical cell is capable of detecting at least one compound selected from the group consisting of: a porphyrin, a metalloporphyrin, a porphyrin derivative, a metalloporphyrin derivative, a porphyrin-like macrocycle, and any combination thereof; and a receiver coupled to the spectroelectrochemical cell, the receiver capable of receiving one or more detection signals from the spectroelectrochemical cell.

An embodiment of the present disclosure is a method comprising: positioning a spectroelectrochemical cell in a wellbore penetrating at least a portion of a subterranean formation comprising a downhole fluid; allowing at least a portion of the downhole fluid to flow into the spectroelectrochemical cell; and detecting at least one compound in at least a portion of the downhole fluid, wherein the at least one compound is selected from the group consisting of: a porphyrin, a metalloporphyrin, a porphyrin derivative, a porphyrin-like macrocycle, and any combination thereof, wherein the detecting comprises cyclic voltammetry and electromagnetic spectroscopy.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
positioning a spectroelectrochemical cell in a wellbore penetrating at least a portion of a subterranean formation comprising a downhole fluid;
allowing at least a portion of the downhole fluid to flow into the spectroelectrochemical cell; and
detecting at least one compound in at least a portion of the downhole fluid, wherein the at least one compound is selected from the group consisting of: a porphyrin, a metalloporphyrin, a porphyrin derivative, a porphyrin-like macrocycle, and any combination thereof.

2. The method of claim 1, wherein the porphyrin-like macrocycle is selected from the group consisting of: a corrin, a corrole, a chlorin, a bacteriochlorin, a phthalocyanine, and any combination thereof.

3. The method of claim 1, wherein the detecting comprises exposing the at least a portion of the downhole fluid to electromagnetic radiation.

4. The method of claim 1, wherein the detecting comprises applying a voltage potential to the at least a portion of the downhole fluid.

5. The method of claim 1, wherein the detecting comprises determining a concentration of the at least one compound in the downhole fluid.

6. The method of claim 1, further comprising generating a detection signal from the spectroelectrochemical cell.

7. The method of claim 6, wherein the detection signal is indicative of the concentration of the at least one compound in the downhole fluid.

8. A system comprising:
a spectroelectrochemical cell capable of being located in a wellbore penetrating at least a portion of a subterranean formation comprising a downhole fluid, wherein the spectroelectrochemical cell is capable of detecting at least one compound selected from the group consisting of: a porphyrin, a metalloporphyrin, a porphyrin derivative, a metalloporphyrin derivative, a porphyrin-like macrocycle, and any combination thereof; and
a receiver coupled to the spectroelectrochemical cell, the receiver capable of receiving one or more detection signals from the spectroelectrochemical cell.

9. The system of claim 8, wherein the porphyrin-like macrocycle is selected from the group consisting of: a corrin, a corrole, a chlorin, a bacteriochlorin, a phthalocyanine, and any combination thereof.

10. The system of claim 8, wherein the one or more detection signals are indicative of the concentration of the at least one compound in the downhole fluid.

11. The system of claim 8, further comprising a downhole tool comprising the spectroelectrochemical cell.

12. The system of claim 8, wherein the spectroelectrochemical cell is coupled to a wireline, slickline, work string, or drill string.

13. The system of claim 8, wherein the one or more detection signals comprise at least one of a voltammetry signal and an electromagnetic radiation absorption signal.

14. The system of claim 8, wherein the spectroelectrochemical cell comprises an electromagnetic radiation source and a detector.

15. The system of claim 8, wherein the spectroelectrochemical cell is coupled to an electromagnetic radiation source and a detector.

15. The system of claim 8, wherein the spectroelectrochemical cell comprises a voltage source and a current detector.

16. The system of claim 8, wherein the spectroelectrochemical cell is coupled to a potentiostat.

17. The system of claim 8, wherein the one or more detection signals comprise a cyclic voltammetry signal or an electromagnetic spectroscopy signal.

18. The system of claim 8, wherein the receiver comprises a processor capable of graphically displaying the one or more detection signals.

19. A method comprising:
positioning a spectroelectrochemical cell in a wellbore penetrating at least a portion of a subterranean formation comprising a downhole fluid;
allowing at least a portion of the downhole fluid to flow into the spectroelectrochemical cell; and
detecting at least one compound in at least a portion of the downhole fluid, wherein the at least one compound is selected from the group consisting of: a porphyrin, a metalloporphyrin, a porphyrin derivative, a porphyrin-like macrocycle, and any combination thereof, wherein the detecting comprises cyclic voltammetry and electromagnetic spectroscopy.

20. The method of claim 19, wherein the porphyrin-like macro cycle is selected from the group consisting of: a corrin, a corrole, a chlorin, a bacteriochlorin, a phthalocyanine, and any combination thereof.
